(19) United States
(12) Patent Application Publication
(10) Pub. No.: US 2026/0106191 A1
(43) Pub. Date: Apr. 16, 2026

(54) FUEL CELL EXHAUST DILUTION CONTROL

(71) Applicant: GM Global Technology Operations LLC, Detroit, MI (US)

(72) Inventors: Biju Edamana, Christiansburg, VA (US); Manish Sinha, St. Petersburg, FL (US); Xiaofeng Wang, Troy, MI (US); Chad Dubois, Oxford, MI (US); Sergio Eduardo Garcia, Commerce Township, MI (US)

(21) Appl. No.: 18/913,391

(22) Filed: Oct. 11, 2024

(51) Int. Cl. H01M 8/04746; H01M 8/0444; H01M 8/04791

(52) U.S. Cl. CPC H01M 8/04761; H01M 8/04462; H01M 8/04805

(57) ABSTRACT

A method of controlling selective purging of reacted fuel gas at the anode of a hydrogen fuel cell includes initiating a selective purging of reacted fuel gas, initiating air flow through the fuel cell necessary to dilute a concentration of hydrogen present within the reacted fuel gas exhausted from the fuel cell, and opening an anode valve adapted to allow reacted fuel gas within the anode to vent from the fuel cell after the air flow through the fuel cell reaches an estimated required air flow rate necessary to dilute the level of hydrogen present within the reacted fuel gas exhausted from the fuel cell.

### INTRODUCTION

The present invention relates generally to fuel cells, and particularly to control systems for fuel cells. In some applications fuel cells are designed wherein the fuel and oxidant supply streams are flow-through systems, however, these systems add a parasitic load to the fuel cell output and thus reduce the net power that can be extracted. In other configurations the fuel stream or the oxidant stream or both are “dead-ended”. This dead-ended operation creates issues such as water removal and accumulation of impurities.

Thus, there is a need for an improved fuel cell, fuel cell propulsion system and method of controlling a fuel cell, wherein the flow-through capability of fuel into and through the anode of the fuel cell is controlled with an anode valve, allowing selective flow of reacted fuel gas from the anode to the atmosphere surrounding the fuel cell, with feed-forward based active control of opening the anode valve based on an estimated required air flow rate through the fuel cell and feedback based active control of an air flow device to continuously adjust the air flow through the fuel cell while the anode valve is open.

### SUMMARY

According to several aspects of the present disclosure, a method of controlling selective purging of reacted fuel gas at the anode of a hydrogen fuel cell includes initiating a selective purging of reacted fuel gas, initiating air flow through the fuel cell necessary to dilute a concentration of hydrogen present within the reacted fuel gas exhausted from the fuel cell, and opening an anode valve adapted to allow reacted fuel gas within the anode to vent from the fuel cell after the air flow through the fuel cell reaches an estimated required air flow rate necessary to dilute the level of hydrogen present within the reacted fuel gas exhausted from the fuel cell.

According to another aspect, the initiating a selective purging of reacted fuel gas further includes monitoring, with a first sensor or model, a concentration of hydrogen gas present at an anode of the fuel cell, monitoring, with a second sensor or model, a concentration of water present at the anode of the fuel cell, initiating, with a controller in communication with the first and second sensors or model, a selective purge of reacted fuel gas from the anode side of the fuel cell when the concentration of hydrogen gas present at the anode is less than a predetermined concentration, and initiating, with the controller in communication with the first and second sensors or model, a selective drain of liquid water from the anode side of the fuel cell when the amount of liquid water present at the anode is more than a predetermined amount.

According to another aspect, the initiating air flow through the fuel cell necessary to dilute a concentration of hydrogen present within the reacted fuel gas exhausted from the fuel cell further includes monitoring, with a third sensor or model, a flow rate of air into the fuel cell, estimating, with the controller, a required flow rate of air into the fuel cell necessary to dilute the concentration of hydrogen present within the reacted fuel gas exhausted from the fuel cell below a predetermined level, and increasing, with an air flow device, the flow rate of air into the fuel cell from a normal operating flow rate to the estimated required flow rate.

According to another aspect, the method further includes maintaining the anode valve in a closed position when the air flow device is unable to increase the flow rate of air into the fuel cell to the estimated required flow rate.

According to another aspect, the opening the anode valve adapted to allow reacted fuel gas within the anode to vent from the fuel cell after air flow through the fuel cell reaches an estimated required air flow rate necessary to dilute the level of hydrogen present within the reacted fuel gas exhausted from the fuel cell has been diluted further includes opening the anode valve when the flow rate of air into the fuel cell is at the estimated required flow rate.

According to another aspect, the method further includes continuously, while the anode valve is open, monitoring, with the third sensor or model, the flow rate of air into the fuel cell, re-estimating, with the controller, the required flow rate of air into the fuel cell necessary to dilute the concentration of hydrogen present within the reacted fuel gas below the predetermined level based on feedback from the first and second sensors or model, and adjusting, with the air flow device, the flow rate of air into the fuel cell to the re-estimated required flow rate.

According to another aspect, the method further includes continuously, while the anode valve is open, monitoring, with the third sensor or model, the flow rate of air into the fuel cell, re-estimating, with the controller, the required flow rate of air into the fuel cell necessary to dilute the concentration of hydrogen present within the reacted fuel gas below the predetermined level based on established shutdown leak rates, and adjusting, with the air flow device, the flow rate of air into the fuel cell to the re-estimated required flow rate.

According to another aspect, the method further includes maintaining the flow of air into the fuel cell at the re-estimated required air flow rate, holding the anode valve open for a predetermined time period, and upon closing of the anode valve, reducing, with the air flow device, the flow rate of air into the fuel cell to the normal operating flow rate.

According to another aspect, the initiating air flow through the fuel cell necessary to dilute a concentration of hydrogen present within the reacted fuel gas exhausted from the fuel cell further includes diluting the concentration of hydrogen present within the reacted fuel gas exhausted from the fuel cell to below four percent by volume.

According to another aspect, the method further includes maintaining the anode valve in a closed position when a temperature within the fuel cell is below a predetermined level.

According to several aspects of the present disclosure, a fuel cell includes an anode, a cathode, an electrolyte positioned between the anode and the cathode, and a controller adapted to initiate selective purging of reacted fuel gas within the anode of the fuel cell, initiate air flow through the fuel cell necessary to dilute a concentration of hydrogen present within the reacted fuel gas exhausted from the fuel cell prior to opening an anode valve adapted to allow reacted fuel gas within the anode to vent from the fuel cell, and open the anode valve after the air flow through the fuel cell reaches an estimated required air flow rate necessary to dilute the level of hydrogen present within the reacted fuel gas exhausted from the fuel cell.

According to another aspect, when initiating a selective purging of reacted fuel gas, the controller is further adapted to monitor, with a first sensor or model in communication with the controller, a concentration of hydrogen gas present at the anode of the fuel cell, monitor, with a second sensor model in communication with the controller, an amount of liquid water present at the anode of the fuel cell, initiate a selective purge of reacted fuel gas from the anode of the fuel cell when the concentration of hydrogen gas present at the anode is less than a predetermined concentration, and initiate a selective drain of liquid water from the anode when the amount of water present at the anode is more than a predetermined level.

According to another aspect, when initiating air flow through the fuel cell necessary to dilute the concentration of hydrogen present within the reacted fuel gas exhausted from the fuel cell, the controller 34 is further adapted to monitor, with a third sensor or model, a flow rate of air into the fuel cell, estimate a required flow rate of air into the fuel cell necessary to dilute the concentration of hydrogen present within the reacted fuel gas exhausted from the fuel cell below a predetermined level, increase, with an air flow device, the flow rate of air into the fuel cell from a normal operating flow rate to the estimated required flow rate.

According to another aspect, the controller is further adapted to maintain the anode valve in a closed position when the air flow device is unable to increase the flow rate of air into the fuel cell to the estimated required flow rate.

According to another aspect, the controller is adapted to open the anode valve to allow reacted fuel gas within the anode to vent from the fuel cell after the flow rate of air into the fuel cell is at the estimated required flow rate.

According to another aspect, the controller is further adapted to continuously, while the anode valve is open, monitor, with the third sensor or model, the flow rate of air into the fuel cell, re-estimate the required flow rate of air into the fuel cell necessary to dilute the concentration of hydrogen present within the reacted fuel gas below the predetermined level based on feedback from the first and second sensors and established shutdown leak rates, and adjust, with the air flow device, the flow rate of air into the fuel cell to the re-estimated required flow rate.

According to another aspect, the controller is further adapted to maintain the flow of air into the fuel cell at the re-estimated required air flow rate, hold the anode valve open for a predetermined time period, and upon closing of the anode valve, reduce, with the air flow device, the flow rate of air into the fuel cell to the normal operating flow rate.

According to another aspect, the controller is adapted to dilute the concentration of hydrogen present within the reacted fuel gas exhausted from the fuel cell to below four percent by volume.

According to another aspect, the controller is further adapted to maintain the anode valve in a closed position when a temperature within the fuel cell is below a predetermined level.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a fuel cell propulsion system including a fuel cell according to an exemplary embodiment of the present disclosure;

FIG. 2 is a schematic side view of a fuel cell according to an exemplary embodiment;

FIG. 3 is a schematic block diagram of the fuel cell shown in FIG. 2;

FIG. 4 is a chart plotting actuation of an anode valve within the fuel cell and air flow rate through the fuel cell relative to one another vs. time; and

FIG. 5 is a schematic flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, stationary applications, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

In addition, disclosure of ranges includes disclosure of all values and further divided ranges within the entire range, including endpoints and sub-ranges given for the ranges.

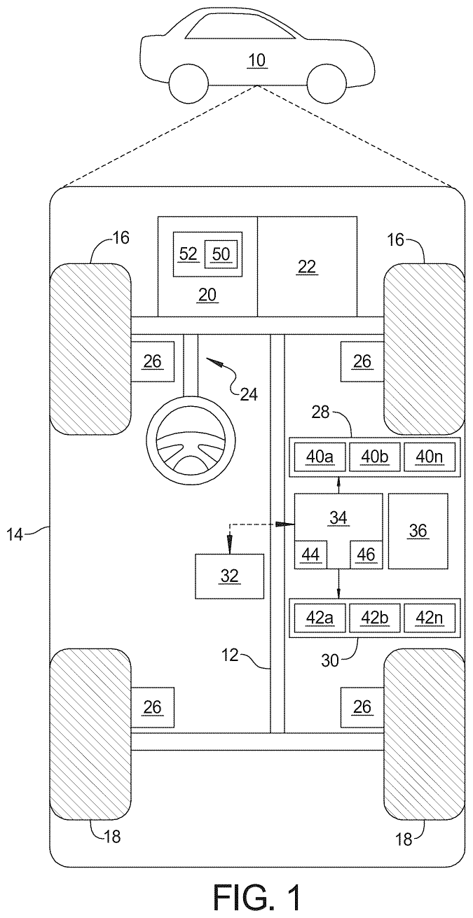

Example embodiments will now be described more fully with reference to the accompanying drawings. In accordance with an exemplary embodiment, FIG. 1 shows a vehicle 10 with an associated fuel cell 50. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a fuel cell propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, powered by the fuel cell 50, or a stack including multiple fuel cells 50, there may be no transmission system 22. The transmission system 22 is configured to transmit power from the fuel cell propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

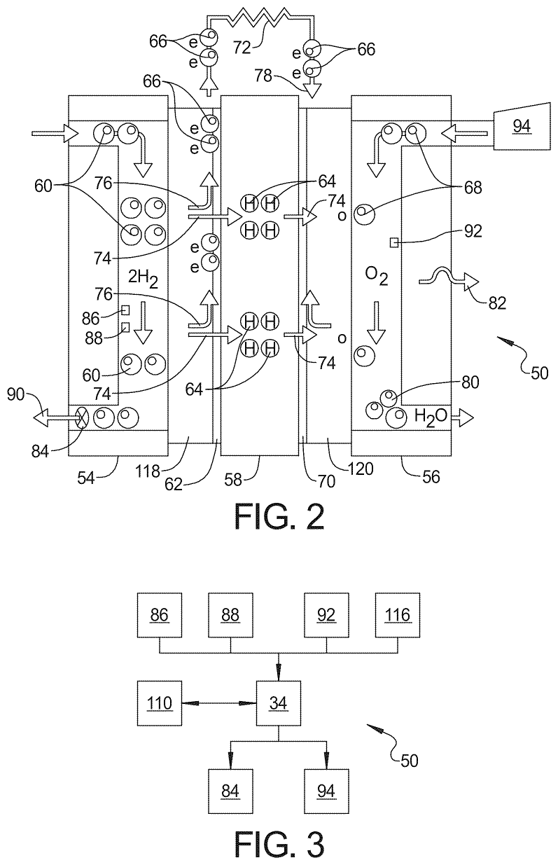

Referring to FIG. 2, the fuel cell propulsion system 20 includes a stack 52 including a plurality of fuel cells 50. In an exemplary embodiment, each fuel cell 50 is a hydrogen fuel cell that is an electro-chemical device in which a free energy change resulting from an oxidation reaction is converted into electrical energy. A fuel cell 50 includes an anode 54 (fuel electrode) and a cathode 56 (oxidant electrode), separated by an ion-conducting electrolyte 58 positioned therebetween. A fuel 60 (typically hydrogen, H₂) capable of chemical oxidation is supplied to the anode 54 and ionizes on a suitable catalyst 62 to produce hydrogen protons (H) 64 and electrons 66. Gaseous hydrogen 60 has high reactivity in the presence of a suitable catalyst 62 and high energy density. Similarly, an oxidant 68 (typically air, O₂) is supplied to the fuel cell cathode 56 and reacts with a suitable catalyst 70 at the cathode 56. Gaseous oxygen 68 is readily and economically available from the air for fuel cells. The anode 54 receives hydrogen gas 60 and the cathode 56 receives oxygen 68 or air.

The hydrogen gas 60 is dissociated in the anode 54 to generate free hydrogen protons 64 and electrons 66. The anode 54 and cathode 56 are connected electrically to a load 72 (such as an electronic circuit) by an external circuit conductor. The hydrogen protons 64 pass through the electrolyte 58 to the cathode 56, as indicated by arrow 74. The electrons 66 from the anode 54 cannot pass through the electrolyte 58, and thus are directed through the load 72, as indicated by arrow 76, to perform work before being sent to the cathode 56, as indicated by arrow 78. Proton exchange membrane fuel cells (PEMFC) are a popular fuel cell type for vehicles, and generally includes a solid polymer electrolyte proton conducting membrane for an electrolyte 58, such as a perfluorosulfonic acid membrane. The catalysts 62, 70 of the anode 54 and cathode 56 typically include finely divided catalytic particles, usually platinum (Pt), supported on carbon particles and mixed with an ionomer, where the catalytic mixture is deposited on opposing sides of the electrolyte membrane 58. The combination of the anode catalytic mixture (anode catalyst 62), the cathode catalytic mixture (cathode catalyst 70), gas diffusion layers 118, 120, and the membrane (electrolyte 58) define a membrane electrode assembly (MEA). The membranes block the transport of gases between the anode side 54 and the cathode side 56 of the fuel cell 50 while allowing the transport of protons 64 to complete the anodic and cathodic reactions on their respective electrodes 54, 56. At the cathode 56, oxygen gas 68 reacts with the hydrogen protons 64 migrating through the electrolyte 58 and the incoming electrons 66 from the external circuit to produce water 80 as a byproduct. The byproduct water 80 is typically extracted as vapor. The overall reaction that takes place in the fuel cell 50 is the sum of the anode 54 and cathode 56 reactions, with part of the free energy of reaction released directly as electrical energy (used by the load 72). The difference between this available free energy and the heat of reaction is produced as heat, as indicated by arrow 82.

In an exemplary embodiment, several fuel cells 50 are combined in a fuel cell stack 52 to generate the desired power. A fuel cell stack 52 typically includes a series of flow field or bipolar plates positioned between the several MEAs in the stack 52, where the bipolar plates and the MEAs are positioned between two end plates. The bipolar plates include an anode side and a cathode side for adjacent fuel cells 50 in the stack 52. Anode gas flow channels are provided on the anode side of the bipolar plates that allow the anode reactant gas 60 to flow to the respective MEA. Cathode gas flow channels are provided on the cathode side of the bipolar plates that allow the cathode reactant gas 68 to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack 52. The bipolar plates also include flow channels through which a cooling fluid flows. The fuel (hydrogen) 60 and oxidant (air) 68 are introduced through manifolds to their respective electrodes 54, 56. In some applications the fuel 60 and oxidant 68 supply streams are designed as flow-through systems, however, these systems add a parasitic load to the fuel cell 50 output and thus reduce the net power that can be extracted. In other configurations the fuel stream or the oxidant stream or both are “dead-ended”. This dead-ended operation creates issues such as water removal and accumulation of impurities. Thus, in an exemplary embodiment of the present disclosure, the flow-through capability of fuel 60 into and through the anode side 54 of the fuel cell 50 is controlled with an anode valve 84 or anode valves, allowing selective flow of reacted fuel gas 90 from the anode 54 to the atmosphere surrounding the fuel cell 50.

The MEAs in the fuel cells 50 are permeable and thus allow nitrogen in the air from the cathode side 56 of the stack to permeate through and collect in the anode side 54 of the stack 52, often referred to as nitrogen cross-over. Even though the anode side 54 pressure may be slightly higher than the cathode side 56 pressure, cathode side 56 partial pressures will cause air to permeate through the electrolyte membrane 58. Nitrogen in the anode side 54 of the fuel cell 50 dilutes the hydrogen 60 such that if the nitrogen concentration increases above a certain percentage, such as 50%, fuel cells 50 in the stack 52 may become starved of hydrogen 60. If a fuel cell 50 becomes hydrogen starved, the fuel cell stack 52 will fail to produce adequate electrical power and may suffer damage to the electrodes 54, 56 in the fuel cell stack 52. Further, under heavy load, evaporation of water 80 by-product at the cathode 56 takes place slower than formation, and water 80 tends to migrate back through the polymer electrolyte 58 to the anode side 54. Some spots on a fuel cell 50 are cooler than others, and the moisture condenses at these locations into liquid water 80, flooding the anode 54 and impeding the reaction at the anode 54. Additionally, other impurities accumulate at the anode 54, and may poison the anode reaction sites. Inert contaminants also result in loss of performance by lowering the fuel partial pressure. Thus, it is known in the art to provide an anode valve 84 in the anode exhaust gas output line of the fuel cell stack 52 to remove nitrogen and water 80 from the anode side 54 of the stack 52. This allows controlled venting of a proportion (perhaps from 0.1 to 10%) of gaseous fuel or oxidant (reacted fuel gas) through a throttled opening, removing accumulated impurities, water 80 and fine particulates from the anode side 54 and restoring fuel cell 50 performance. For purposes of clarity and to avoid confusion, accumulated gases that are being vented are referred to herein as “reacted fuel gas”. It should be understood to those skilled in the art that reacted fuel gas is mainly hydrogen 60 with trace amounts of water 80 and possibly nitrogen, carbon dioxide and carbon monoxide. Depending on the construction of the fuel cell 50, other gases might also be found in reacted fuel gas.

A fuel cell propulsion system controller includes control algorithms that identify a desirable minimum hydrogen gas 60 concentration in the anode 54, and cause the anode valve 84 to open when the gas concentration falls below that threshold, controlling the length of, and intervals between, successive purges. The fuel cell propulsion system controller may be the vehicle controller 34, or a separate controller, in communication with the vehicle controller 34 and dedicated to controlling the fuel cell propulsion system 20. However, release of hydrogen 60 into the open air may create a safety hazard if the concentration of hydrogen 60 is above four (4) percent by volume. Increasing the flow of air 68 into the cathode side 56 of the fuel cell 50, dilutes the hydrogen 60 present in the purged gas, so when the purged gas reaches the atmosphere surrounding the fuel cell 50, the concentration of hydrogen 60 is low enough to be safely vented into the atmosphere.

It is known in the art to estimate the molar fraction of gases in the anode side 54 of a fuel cell stack 52 using a model to determine when to perform the bleed of the anode side 54 or anode sub-system. For example, gas concentration estimation (GCE) models are known for estimating hydrogen, nitrogen, oxygen, water vapor, etc. in various volumes of a fuel cell system, such as the anode flow-field, anode plumbing, cathode flow-field, cathode header and plumbing, etc. Thus, the controller 34 can determine when to initiate opening of the anode valve 84 for a purge.

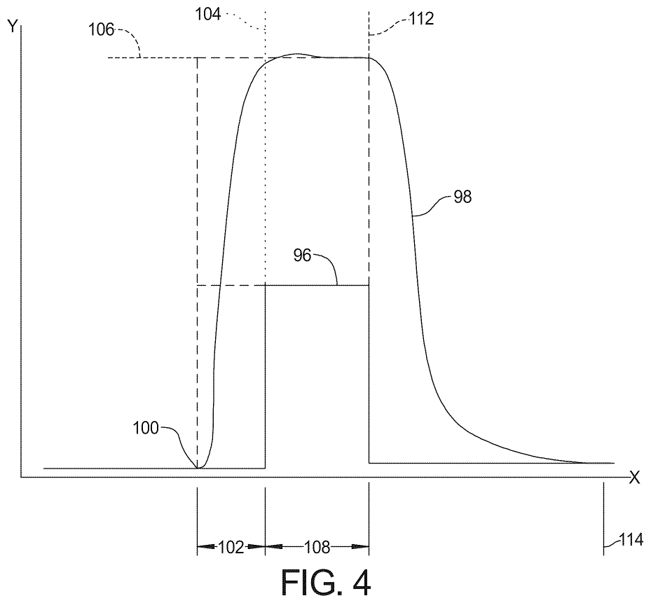

Referring again to FIG. 2 and to FIG. 3, in an exemplary embodiment of the present disclosure, the controller 34 is adapted to monitor, with a first sensor or model 86 in communication with the controller 34, a concentration of hydrogen gas 60 present at the anode 54 of the fuel cell 50, monitor with a second sensor or model 88 in communication with the controller 34, an amount of liquid water 80 present at the anode 54 of the fuel cell 50, and, initiate a selective purge of reacted fuel gas 90 from the anode 54 of the fuel cell 50 when the concentration of hydrogen gas 60 present at the anode 54 is less than a predetermined concentration, and initiate a drain of liquid water from the anode 54 when the amount of liquid water within the anode is above a predetermined threshold.

The system controller 34, using the first sensor or model 86, can detect when the concentration of hydrogen gas 60 within the anode 54 falls due to the presence of too much nitrogen, or other impurities within the reacted fuel gas, thus prompting the controller 34 to initiate a selective purge of the reacted fuel gas 90 from the anode 54. Likewise, the system controller 34, using the second sensor or model 88, can detect when the amount of liquid water 80 within the anode 54 builds to a level impeding the catalytic reaction of hydrogen gas 60 within the anode 54, thus prompting the controller 34 to initiate a selective drain of the liquid water from the anode 54.

Once the controller 34 initiates a selective purge of the anode 54, the controller 34 monitors, with a third sensor or model 92, a flow rate of air 68 into the fuel cell 50, and estimates a required flow rate of air 68 into the fuel cell 50 necessary to dilute the concentration of hydrogen 60 within exhaust from the fuel cell 50 below a predetermined level. As discussed above, a safe concentration of hydrogen 60 in vented reacted fuel gas 90 at the exhaust is less than four percent by volume. The anode 54 is purged of the high concentration H2 (for example, 75%) into the cathode 56 inlet or exhaust. At the same time, high air flow is pushed through the cathode 56 to the exhaust as well. By providing enough extra air, the H2 concentration in exhaust will be below the targeted level. Here there are two options. The first option is to purge to cathode 56 inlet. The second option is to purge to exhaust. The benefit of the first option is that high concentration H2 will be mixed with air in the cathode 56 and react with each other to generate water directly. Therefore, the amount of H2 entering into the exhaust will be largely reduced.

The controller 34, increases the flow rate of air 68 into the fuel cell 50 by actuating an air flow device 94 adapted to push air 68 into the fuel cell 50. The air flow device 94 may be a blower or turbine adapted to pull ambient external air and push the air 68 into the fuel cell 50. The controller 34 increases the force that the air flow device pushes air 68, thus, increasing the volume of air 68 that is pushed through the fuel cell. During normal operating conditions, the air flow device 94 is adapted to deliver air 68 into the fuel cell 50 at a normal operating flow rate. When initiating a purge of the reacted fuel gas 90, the controller actuates the air flow device 94 to increase the flow rate of air 68 entering the fuel cell 50 from the normal operating flow rate to the estimated required flow rate to dilute the concentration of hydrogen 60 present within the reacted fuel gas 90 at the anode 54 to below four percent by volume.

Referring to FIG. 4, a chart plots the opening and closing of the anode valve 84, as indicated by the solid line 96, relative to the air flow rate into the fuel cell 50, as indicated by solid line 98. The x-axis of the chart of FIG. 4 indicates time. The controller 34 initiates a purge at the point indicated at 100. The controller 34 is adapted to keep the anode valve 84 closed until the hydrogen 60 has been diluted, thus, the controller 34 actuates the air flow device 94 prior to opening the anode valve 84. The air flow device 94 is actuated at the point indicated at 100, and takes a period of time, as indicated at 102, to spool up and gradually increase the flow rate of air 68 into the fuel cell 50. At the point indicated by 104, the air flow device 94 successfully increases the flow rate of air 68 entering the fuel cell 50 to the estimated required air flow rate, as indicated by 106. At this point in time, once the estimated required flow rate is achieved, indicating that the concentration of hydrogen 60 within the anode 54 has been diluted, the controller 34 opens the anode valve 84, allowing reacted fuel gas 90 within the anode 54 to vent from the fuel cell 50.

If for any reason, the air flow device 94 is unable to push the air flow into the fuel cell 50 up to the estimated required air flow rate, the controller 34 is adapted to maintain the anode valve 84 in a closed position, preventing an unsafe concentration of hydrogen gas 60 from being vented to the atmosphere surrounding the fuel cell 50.

The controller 34 holds the anode valve 84 open for a predetermined time period, as indicated by 108 in FIG. 4. While the anode valve 84 is open, the controller 34 continuously monitors, with the third sensor 92, the flow rate of air 68 into the fuel cell 50, and re-estimates the required flow rate of air 68 into the fuel cell 50 necessary to keep the concentration of hydrogen gas 60 within the reacted fuel gas 90 within the anode 54 diluted to the pre-determined safe level. The controller 34 uses feedback from the first and second sensors 86, 88 and established shutdown leak rates to fine tune the required air flow rate.

Established shutdown leak rates are stored within a database 110 in communication with the controller 34. Leak rates from the fuel cell 50 are estimated/measured by known methods when the fuel cell 50 is not operating. Such leak rates are used by the controller 34 to estimate and re-estimate required air flow rates, taking into consideration base line leakage of hydrogen gas 60 from the anode 54. Data of established leak rates stored within the database 110 are updated periodically, and the controller 34 may use neural network data techniques to more accurately estimate and calculate, using predictive machine learning algorithms, what air flow rate will be required under identified operating conditions (temperature, power usage, etc.).

Throughout the time when the anode valve 84 is open, the controller 34 continuously adjust the operation of the air flow device 94 and the air flow rate, keeping the air flow rate at the most recently re-estimated required air flow rate necessary to maintain proper dilution of the hydrogen 60 within the anode 54. After the pre-determined time period 108 has passed, the controller 34 closes the anode valve 84, as indicated at 112 in FIG. 4, and actuates the air flow device 94 to return the flow of air into the fuel cell to the normal operating flow rate, wherein the flow rate gradually falls back to the normal operating flow rate, as indicated at 114.

In an exemplary embodiment, the controller 34 is further adapted to maintain the anode valve 84 in a closed position when a temperature, as measured by a fourth sensor or model 116 within the fuel cell 50 is below a predetermined level. Components of a fuel cell include the electrolyte membrane 58, catalyst layers 62, 70, gas diffusion layers 118, 120, micro-porous layer and bipolar plate. Hydrogen and air flows pass through the anode 54 and cathode 56 flow channels, respectively. Diffusion and convection of the gases co-exist in the porous layers. The catalyst layers 62, 70 are comprised of a mixture of catalyst particles, ionomer, and porous carbon backbone. Electrochemical reactions occur on the three-phase coexistence sites (ionomer, gas, and catalyst) in the catalyst layers 62, 70. Electricity is generated during operation, along with water as the reaction product. During a cold start, water transforms from one phase or state to another. It can be absorbed by the ionomer and become membrane water. Part of the membrane water can transform to frozen membrane water due to subfreezing temperatures. Water can also evaporate from the ionomer. The resulting vapor percolates through the porous layers and enters into the flow channel. Water vapor can also deposit and accumulate in the porous layers as ice. Lastly, water can stay in a supercooled liquid state under certain conditions. During a cold start, temperature rises due to the exothermic electrochemical reaction. A successful cold start requires that the catalyst layers 62, 70 temperature exceeds the ice's melting point before the reaction sites and diffusion pathways are blocked. In this case, ice melts and liquid water can be drained, thus, the controller keeps the anode valve 84 closed until such temperatures within the fuel cell 50 are reached.

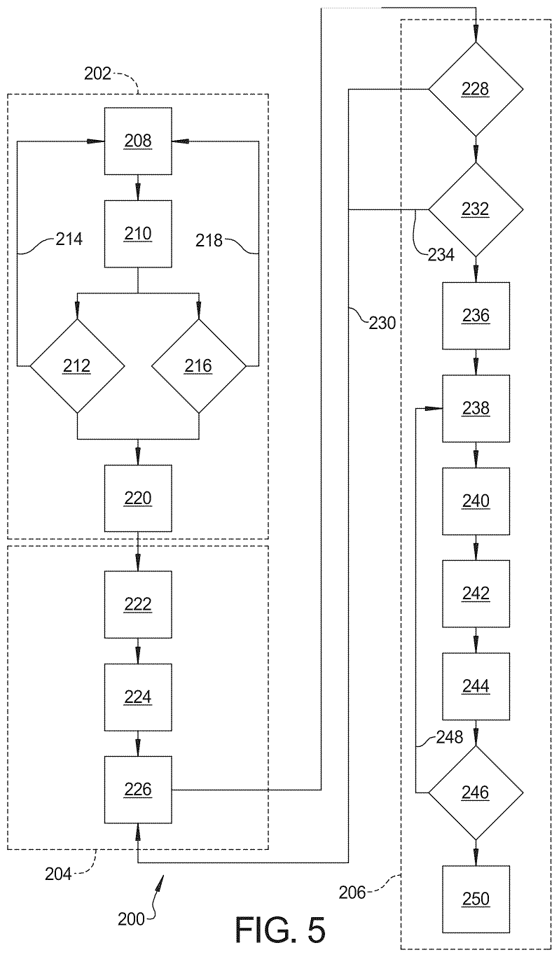

Referring to FIG. 5, a method 200 of controlling selective purging of reacted fuel gas 90 at the anode 54 of a hydrogen fuel cell 50, includes, beginning at block 202, initiating a selective purging of reacted fuel gas, moving to block 204, diluting a concentration of hydrogen 60 present within the reacted fuel gas 90, and, moving to block 206, opening an anode valve 84 adapted to allow reacted fuel gas 90 within the anode 54 to vent from the fuel cell 50 after the level of hydrogen 60 present within the reacted fuel gas 90 has been diluted.

In an exemplary embodiment, the initiating a selective purging of reacted fuel gas 90 at block 202 further includes, moving to block 208, monitoring, with a first sensor 86, a concentration of hydrogen gas 60 present at an anode 54 of the fuel cell 50, and, moving to block 210, monitoring, with a second sensor 88, a concentration of water 80 present at the anode 54 of the fuel cell 50. Moving to block 212, if the concentration of hydrogen gas 60 present at the anode 54 is less than a predetermined concentration, or, moving to block 216, if the concentration of water 80 present at the anode 54 is more than a predetermined concentration, then, moving to block 220, the method 200 includes initiating, with a controller 34 in communication with the first and second sensors 86, 88, a selective purge of reacted fuel gas 90 from the anode 54 side of the fuel cell 50. If, at block 212, the concentration of hydrogen gas 60 present at the anode 54 is not less than the predetermined concentration, then the method 200 reverts back to block 208, as indicated by line 214. If, at block 216, the concentration of water 80 present at the anode 54 is not more than a predetermined concentration, then the method 200 reverts back to block 208, as indicated by line 218.

In another exemplary embodiment, the diluting the concentration of hydrogen 60 present within the reacted fuel gas 90 at block 204 further includes, moving to block 222, monitoring, with a third sensor 92, a flow rate of air into the fuel cell 50, moving to block 224, estimating, with the controller 34, a required flow rate of air into the fuel cell 50 necessary to dilute the concentration of hydrogen 60 present within the reacted fuel gas 90 below a predetermined level, and, moving to block 226, increasing, with an air flow device 94, the flow rate of air into the fuel cell 50 from a normal operating flow rate to the estimated required flow rate.

In another exemplary embodiment, moving to block 228, if the air flow device 94 is unable to increase the flow rate of air into the fuel cell to the estimated required flow rate, then, the method 200 reverts to block 226, as indicated by line 230, wherein the air flow rate is being increased and the anode valve 84 is maintained in a closed position. Moving again to block 228, if the air flow device 94 is able to increase the flow rate of air, and the flow rate of air into the fuel cell 50 is at the estimated required flow rate, then, moving to block 236, the method 200 includes opening the anode valve 84 to allow reacted fuel gas 90 within the anode 54 to vent from the fuel cell 50. In another exemplary embodiment, if at block 228, the air flow rate is at the estimated required flow rate, then, moving to block 232, if the temperature of the fuel cell 50 is below a predetermined level, the method 200 again reverts back to block 226, as indicated by line 230, wherein the air flow rate is being increased and the anode valve 84 is maintained in a closed position. At very low temperatures, cathode stoichiometry may be kept low to generate more heat. Therefore, the anode valve is closed, but the air flow may not be increased.

In another exemplary embodiment, once the anode valve 84 is opened at block 236, the method 200 further includes, continuously for the entire time the anode valve 84 is open, moving to block 238, monitoring, with the third sensor 92, the flow rate of air into the fuel cell 50, moving to block 240, re-estimating, with the controller 34, the required flow rate of air into the fuel cell 50 necessary to dilute the concentration of hydrogen 60 present within the reacted fuel gas 90 below the predetermined level based on feedback from the first and second sensors 86, 88, and based on established shutdown leak rates, and, moving to block 242, adjusting, with the air flow device 94, the flow rate of air into the fuel cell 50 to the re-estimated required flow rate.

Moving to block 244, the method 200 includes maintaining the flow of air into the fuel cell 50 at the re-estimated required air flow rate and holding the anode valve 84 open for a predetermined time period. Moving to block 246, if the predetermined time period has not passed and the anode valve is still open, then the method 200 reverts back to block 238, as indicated by line 248. If, at block 246, the predetermined time period has passed and the anode valve 84 is closed, then, moving to block 250, the method 200 includes reducing, with the air flow device 94, the flow rate of air into the fuel cell 50 to the normal operating flow rate.

A fuel cell 50, fuel cell propulsion system 20 and method 200 of the present disclosure offers several advantages. These include determining how much air flow is required to dilute exiting reacted fuel gas 90 within the anode 54 such that concentration of hydrogen gas 60 therein is low enough to be safely vented to atmosphere, and using a feed-forward strategy to automatically stall initiation of venting of the reacted fuel gas 90 from the anode 54 until sufficient air flow from the air flow device 94 is present, thus, insuring that vented reacted fuel gas 90 contains appropriate levels of hydrogen gas 60 therein. Further, feedback from the first and second sensors 86, 88 as well as stored data related to established shut down leak rates is used to continuously update the required air flow needed to maintain appropriate levels of hydrogen gas 60 within the reacted fuel gas 90, and actively control the air flow device 94 to consistently maintain appropriate air flow through the fuel cell 50 throughout the time venting of reacted fuel gas 90 through the anode valve 84 is taking place, and, once venting of reacted fuel gas 90 through the anode valve 84 is complete, and the anode valve 84 is closed, actively controlling the air flow device 94 to bring the air flow through the fuel cell 50 back to a normal operating air flow rate. These features allow the fuel cell 50 to incorporate a larger anode valve 84, allowing more efficient venting of the reacted fuel gas 90, improving signal to noise ratio for phase change detection that triggers conclusion of venting, provides easier diagnosis of a stuck anode valve 84 condition, and improves electrolyte membrane 58 durability, making the fuel cell 50 more robust. Further, the fuel cell 50, fuel cell propulsion system 20 and method 200 of the present disclosure enables cold and wet fuel cell stack 52 operation, improving durability of the electrolyte membrane 58 without using additional components, such as an anode recirculation pump, and maintains a lower average hydrogen gas 60 level within the anode 54, improving efficiency. Finally, the fuel cell 50, fuel cell propulsion system 20 and method 200 of the present disclosure requires higher dilution air flow only when the anode valve 84 is to be opened, thereby improving efficiency at low and mid power range operation, and if the required air flow cannot be achieved, the anode valve 84 is maintained in a closed position and other known strategies are used during operation of the fuel cell 50. The feedback based continuous active control of the air flow device 94 allows for accommodation of anode valve 84 size variation and wear and part-to-part tolerancing variation.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of controlling selective purging of reacted fuel gas at the anode of a hydrogen fuel cell, comprising:
initiating a selective purging of reacted fuel gas;
initiating air flow through the fuel cell necessary to dilute a concentration of hydrogen present within the reacted fuel gas exhausted from the fuel cell; and
opening an anode valve adapted to allow reacted fuel gas within the anode to vent from the fuel cell after the air flow through the fuel cell reaches an estimated required air flow rate necessary to dilute the level of hydrogen present within the reacted fuel gas exhausted from the fuel cell.

2. The method of claim 1, wherein the initiating a selective purging of reacted fuel gas further includes:
monitoring, with a first sensor or model, a concentration of hydrogen gas present at an anode of the fuel cell;
monitoring, with a second sensor or model, a concentration of water present at the anode of the fuel cell;
initiating, with a controller in communication with the first and second sensors or model, a selective purge of reacted fuel gas from the anode side of the fuel cell when the concentration of hydrogen gas present at the anode is less than a predetermined concentration; and
initiating, with the controller in communication with the first and second sensors or model, a selective drain of liquid water from the anode side of the fuel cell when the amount of liquid water present at the anode is more than a predetermined amount.

3. The method of claim 2, wherein the initiating air flow through the fuel cell necessary to dilute a concentration of hydrogen present within the reacted fuel gas exhausted from the fuel cell further includes:
monitoring, with a third sensor or model, a flow rate of air into the fuel cell;
estimating, with the controller, a required flow rate of air into the fuel cell necessary to dilute the concentration of hydrogen present within the reacted fuel gas exhausted from the fuel cell below a predetermined level; and
increasing, with an air flow device, the flow rate of air into the fuel cell from a normal operating flow rate to the estimated required flow rate.

4. The method of claim 3, further including maintaining the anode valve in a closed position when the air flow device is unable to increase the flow rate of air into the fuel cell to the estimated required flow rate.

5. The method of claim 3, wherein the opening the anode valve adapted to allow reacted fuel gas within the anode to vent from the fuel cell after air flow through the fuel cell reaches an estimated required air flow rate necessary to dilute the level of hydrogen present within the reacted fuel gas exhausted from the fuel cell has been diluted further includes opening the anode valve when the flow rate of air into the fuel cell is at the estimated required flow rate.

6. The method of claim 5, further including, continuously while the anode valve is open:
monitoring, with the third sensor or model, the flow rate of air into the fuel cell;
re-estimating, with the controller, the required flow rate of air into the fuel cell necessary to dilute the concentration of hydrogen present within the reacted fuel gas below the predetermined level based on feedback from the first and second sensors or model; and
adjusting, with the air flow device, the flow rate of air into the fuel cell to the re-estimated required flow rate.

7. The method of claim 6, further including, continuously while the anode valve is open:
monitoring, with the third sensor or model, the flow rate of air into the fuel cell;
re-estimating, with the controller, the required flow rate of air into the fuel cell necessary to dilute the concentration of hydrogen present within the reacted fuel gas below the predetermined level based on established shutdown leak rates; and
adjusting, with the air flow device, the flow rate of air into the fuel cell to the re-estimated required flow rate.

8. The method of claim 7, further including:
maintaining the flow of air into the fuel cell at the re-estimated required air flow rate;
holding the anode valve open for a predetermined time period; and
upon closing of the anode valve, reducing, with the air flow device, the flow rate of air into the fuel cell to the normal operating flow rate.

9. The method of claim 8, wherein the initiating air flow through the fuel cell necessary to dilute a concentration of hydrogen present within the reacted fuel gas exhausted from the fuel cell further includes diluting the concentration of hydrogen present within the reacted fuel gas exhausted from the fuel cell to below four percent by volume.

10. The method of claim 9, further including maintaining the anode valve in a closed position when a temperature within the fuel cell is below a predetermined level.

11. A fuel cell, comprising:
an anode, a cathode, an electrolyte positioned between the anode and the cathode; and
a controller adapted to:
initiate selective purging of reacted fuel gas within the anode of the fuel cell;
initiate air flow through the fuel cell necessary to dilute a concentration of hydrogen present within the reacted fuel gas exhausted from the fuel cell prior to opening an anode valve adapted to allow reacted fuel gas within the anode to vent from the fuel cell; and
open the anode valve after the air flow through the fuel cell reaches an estimated required air flow rate necessary to dilute the level of hydrogen present within the reacted fuel gas exhausted from the fuel cell.

12. The fuel cell of claim 11, wherein, when initiating a selective purging of reacted fuel gas, the controller is further adapted to:
monitor, with a first sensor or model in communication with the controller, a concentration of hydrogen gas present at the anode of the fuel cell;
monitor, with a second sensor model in communication with the controller, an amount of liquid water present at the anode of the fuel cell;
initiate a selective purge of reacted fuel gas from the anode of the fuel cell when the concentration of hydrogen gas present at the anode is less than a predetermined concentration; and
initiate a selective drain of liquid water from the anode when the amount of water present at the anode is more than a predetermined level.

13. The fuel cell of claim 12, wherein, when initiating air flow through the fuel cell necessary to dilute the concentration of hydrogen present within the reacted fuel gas exhausted from the fuel cell, the controller 34 is further adapted to:
monitor, with a third sensor or model, a flow rate of air into the fuel cell;
estimate a required flow rate of air into the fuel cell necessary to dilute the concentration of hydrogen present within the reacted fuel gas exhausted from the fuel cell below a predetermined level;
increase, with an air flow device, the flow rate of air into the fuel cell from a normal operating flow rate to the estimated required flow rate.

14. The fuel cell of claim 13, wherein the controller is further adapted to maintain the anode valve in a closed position when the air flow device is unable to increase the flow rate of air into the fuel cell to the estimated required flow rate.

15. The fuel cell of claim 14, wherein the controller is adapted to open the anode valve to allow reacted fuel gas within the anode to vent from the fuel cell after the flow rate of air into the fuel cell is at the estimated required flow rate.

16. The fuel cell of claim 15, wherein the controller is further adapted to continuously, while the anode valve is open:
monitor, with the third sensor or model, the flow rate of air into the fuel cell;
re-estimate the required flow rate of air into the fuel cell necessary to dilute the concentration of hydrogen present within the reacted fuel gas below the predetermined level based on feedback from the first and second sensors and established shutdown leak rates; and
adjust, with the air flow device, the flow rate of air into the fuel cell to the re-estimated required flow rate.

17. The fuel cell of claim 16, wherein the controller is further adapted to:
maintain the flow of air into the fuel cell at the re-estimated required air flow rate;
hold the anode valve open for a predetermined time period; and
upon closing of the anode valve, reduce, with the air flow device, the flow rate of air into the fuel cell to the normal operating flow rate.

18. The fuel cell of claim 17, wherein the controller is adapted to dilute the concentration of hydrogen present within the reacted fuel gas exhausted from the fuel cell to below four percent by volume.

19. The method of claim 18, wherein the controller is further adapted to maintain the anode valve in a closed position when a temperature within the fuel cell is below a predetermined level.

20. A vehicle having a fuel cell propulsion system including at least one fuel cell, comprising:
an anode, a cathode, an electrolyte positioned between the anode and the cathode; and
a controller adapted to:
monitor, with a first sensor or model in communication with the controller, a concentration of hydrogen gas present at the anode of the fuel cell;
monitor, with a second sensor or model in communication with the controller, the amount of liquid water accumulated in the anode of the fuel cell;
initiate a selective purge of reacted fuel gas from the anode of the fuel cell when the concentration of hydrogen gas present at the anode is less than a predetermined concentration; and
initiate a selective drain of liquid water from the anode when the amount of liquid water within the anode is more than a predetermined level;
monitor, with a third sensor or model, a flow rate of air into the fuel cell;
estimate a required flow rate of air into the fuel cell necessary to dilute the concentration of hydrogen present within the reacted fuel gas below a predetermined level;
increase, with an air flow device, the flow rate of air into the fuel cell from a normal operating flow rate to the estimated required flow rate to dilute a concentration of hydrogen present within the reacted fuel gas exhausted from the fuel cell to below a target level prior to opening an anode valve adapted to allow reacted fuel gas within the anode to vent from the fuel cell;
maintain the anode valve in a closed position when the air flow device is unable to increase the flow rate of air into the fuel cell to the estimated required flow rate;
open the anode valve to allow reacted fuel gas within the anode to vent from the fuel cell after the flow rate of air into the fuel cell is at the estimated required flow rate;
continuously, while the anode valve is open:
monitor, with the third sensor or model, the flow rate of air into the fuel cell;
re-estimate the required flow rate of air into the fuel cell necessary to dilute the concentration of hydrogen present within the reacted fuel gas below the predetermined level based on feedback from the first and second sensors or model and established shutdown leak rates; and
adjust, with the air flow device, the flow rate of air into the fuel cell to the re-estimated required flow rate;
maintain the flow of air into the fuel cell at the re-estimated required air flow rate;
hold the anode valve open for a predetermined time period; and
upon closing of the anode valve, reduce, with the air flow device, the flow rate of air into the fuel cell to the normal operating flow rate.
